(19) United States
(12) Patent Application Publication
(10) Pub. No.: US 2008/0230471 A1
(43) Pub. Date: Sep. 25, 2008

(54) FUNCTIONAL FILTER MEDIUM

(75) Inventors: Masao TAMADA, Takasaki-Shi (JP); Noriaki SEKO, Takasaki-Shi (JP); Yuji UEKI, Takasaki-Shi (JP); Toshihide TAKEDA, Osaka-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KURASHIKI TEXTILE MANUFACTURING CO. LTD., Osaka (JP)

(21) Appl. No.: 12/053,019

(22) Filed: Mar. 21, 2008

(30) Foreign Application Priority Data
Mar. 23, 2007 (JP) 2007-076685

(51) Int. Cl. B01D 39/16

(52) U.S. Cl. 210/505

(57) ABSTRACT

This invention relates to functional nonwoven filter media provided by radiation-induced graft copolymerization and its production method. Meltblown type of nonwoven (Meltblown) comprised of fine fibers, less than 8 micron in diameter, of polyolefin or polyamide is chosen as the suitable grafting trunk polymer. The production methods are composed of following steps, 1) irradiation less than 30 kGy dose to the Meltblown with electron beam or gamma ray; 2) graft copolymerization of emulsified vinyl monomer onto the Meltblown; and 3) chemical conversion of ion exchange group onto the grafted vinyl monomer. These steps are independently conducted in their suitable operation conditions.

### BACKGROUND OF THE INVENTION

1. Field of the Invention

This invention relates to functional nonwoven filter media provided by radiation-induced graft copolymerization and its production method. Meltblown type of nonwoven (Hereafter it is called simply “Meltblown”.) comprised of fine fibers, less than 8 micron in diameter, of polyolefin or polyamide is chosen as the suitable grafting trunk polymer.

The production methods are composed of following steps,
1) irradiation less than 30 kGy dose to the Meltblown with electron beam or gamma ray;
2) graft copolymerization of emulsified vinyl monomer onto the Meltblown; and
3) chemical conversion to ion exchange group onto the grafted vinyl monomer.

These steps are independently conducted in their suitable operation conditions.

This functional Meltblown is applied for liquid filtration which can adsorb metal ion dissolving in pure water which is industrially used in the field of semi-conductor, medical and food application. This functionalized Meltblown can be applied for air purification filter to adsorb industrially harmful gases existing in the clean room.

2. Description of the Related Art

In conventional radiation-induced grafting method, considerably high dose of irradiation, for instance, reaching up to 200 kGy and higher has been irradiated in order to obtain high grafting ratio.

Here, grafting ratio (%) is defined as follows. The desirable range of the grafting ratio is expected over than 100% for practical filtration materials.

Grafting Ratio(%)=(Wg−Wo)/Wo×100

where,

Wg: the weight of grafted nonwoven media

Wo: the weight of nonwoven media before grafting

In general, however, irradiation accompanies excessive degradation of trunk polymer and causes severe damage in its physical properties. Therefore, the nonwoven material for the graft copolymerization is confined in a kind of irradiation-durable polymers. As well known, polyethylene has cross-linking nature rather than polymer degradation, so that the physical properties can be somewhat retained under high dosing of irradiation.

For this reason, staple fibers of high density polyethylene (HDPE) which have around 20 micron and more larger in diameter has been used to make nonwoven material.

In such case of nonwoven fabrication, short staple fibers are fed into so-called “Carding machine” to make continuous web and are thermally bonded one another. This type of nonwoven is called “Thermal Bonding” nonwoven.

In this invention, it has been found that the fiber diameter plays significant rolls for radiation-induced graft copolymerization. It is simply related to the total surface area of fibers composing nonwoven. Therefore, the use of the nonwoven comprised of fine fiber is advantageous in graft copolymerization because of its large contact area with reactive monomer.

However, in the production of Thermal Bonding nonwoven, it is very hard to make carding web applying fine fiber less than 10 micron due to mechanically limited carding condition. Therefore, HDPE staple fibers having large diameter over than 20 micron has been used. In such case, high irradiation dose and long graft reaction time was taken in order to obtain high grafting ratio.

Moreover, as long as using short staple fiber, the nonwoven contains small lint which originates from the fiber cutting and such kind of lint often turns to un-preferable dust.

The preparation condition of reactive monomer is also important in graft copolymerization. It sensitively affects on graft reaction.

So far, pure monomer or monomer diluted by organic solvent like ethanol or dimethylsulfoxide was used to realize high penetration into fibers. However, the use of such organic solvent rises the costs highly to satisfy the requirement from environmental protection.

From this aspect, the water-based emulsion grafting technology shown in Unexamined Japanese Patent Application Laid-Open Specification No. 2005-344047 is considered to be more preferable as organic solvent-free process.

However, the graft reaction in emulsified vinyl monomer takes long reaction time and high dose of irradiation have been necessary to achieve high grafting ratio.

### SUMMARY OF THE INVENTION

The key factor of this invention is to use Meltblown which is comprised of fine fiber less than 8 micron in diameter(*).

(*)Note: The fiber diameter means average size in the Meltblown.

The raw material is chosen among polyolefin or polyamide group as suitable trunk polymer material. This kind of Meltblown is first irradiated by electron beam or gamma ray. After irradiation, the Meltblown is immersed in emulsion state of vinyl monomer filled in a vessel to conduct the graft coplolymerization.

Use of vinyl monomer emulsified by mixing surfactant and water is another key factor in this invention. In combining theses two factors, high grafting ratio under low dose of irradiation less than 30 kGy is achieved. After the graft copolymerization, ion exchange group is converted onto thus grafted functional monomer.

Fundamentally, this invention is featured as follows.

The first aspect of the present invention is a functional filter medium obtained by a process comprising;
(a) subjecting a nonwoven fabric to irradiation with electron beam or gamma-ray at a dose of less than 30 kGy in air or nitrogen atmosphere, said nonwoven fabric being a meltblown nonwoven fabric comprising fibers of a polyolefin and/or polyamide each having a diameter less than 8 microns, to thereby obtain an irradiated nonwoven fabric; and
(b) subjecting said irradiated nonwoven fabric to liquid-phase graft copolymerization by contacting said irradiated nonwoven fabric with a reactive monomer emulsified in a continuous phase liquid, said reactive monomer having a functional group, to thereby obtain said functional filter medium.

The second aspect of the present invention is the filter medium according to the first aspect, wherein said process further comprises converting said functional group to at least one ion exchange group.

The third aspect of the present invention is the filter medium according to the second aspect, wherein said ion exchange group is at least one member selected from the group consisting of a sulfonic acid group, an amino group and an imino-diacetic acid (IDA) group.

The fourth aspect of the present invention is the filter medium according to the first aspect, wherein said polyolefin is at least one member selected from the group consisting of a polypropylene, a polyethylene, an ethylene-propylene copolymer and an ethylene-alpha olefin copolymer.

The fifth aspect of the present invention is the filter medium according to the first aspect, wherein said reactive monomer has a vinyl group and is emulsified in water as said continuous phase liquid using a surfactant.

Additionally, this invention also includes following cases.
1) As to polyamide applied here is a kind of polymer composed with amido chain (—CONH—), for instance, polyamide-3, polyamide-4, polyamide-6, polyamide 66, polyamide-12, etc.
2) The surface active agent is chosen among anionic, cationic, zwitterionic and nonionic surfactant or their compounds.
3) The vinyl monomer for graft copolymerization is chosen preferably in the following monomers, acrylonitrile, glycidyl methacrylate, glycidyl vinylbenzylether and chloromethylstyrene. Once grafted on the Meltblown fibers, ion exchange group is converted onto these grafted vinyl group.

This functional Meltblown is further processed by pleating or wounding machine to construct cartridge unit used in the field of liquid filtration.

In addition to the way of application, PTFE or polyethylene membrane or non-grafted polyolefin Meltblown can be co-pleated or co-winded together with said grafted functional Meltblown to have two important functions, i.e., ion adsorption and fine particle (dust) filtration.

### DETAILS OF PRODUCTION METHOD

Following descriptions express the details of the production method of the functional Meltblown. The method fundamentally consists of following stepwise operations, namely, 1) Irradiation, 2) Graft copolymerization and 3) Conversion of ion exchange group onto grafted functional group.

### Preparation

Before grafting operation, the grafting media is selected from Meltblown made of abovementioned polyolefin or polyamide group. The mean fiber diameter of the Meltblown is controlled less than 8 micron, and more preferably chosen from 0.2 to 8 micron. Such kind of Meltblown can be obtained by tuning its fabrication condition.

### Step-1 (Irradiation)

The Meltblown is firstly irradiated by electron beam or Co-60 gamma ray in air or nitrogen atmosphere. The dose is limited in the low range less than 30 kGy to prevent excessive polymer degradation.

The irradiated Meltblown is frozen under sub-zero temperature to reserve radicals which originate in the fiber (polymer).

In most case, radical concentrations in the polymer easily migrate to the surface of the crystalline phase and they react with oxygen in air to form diperoxides or hydroperoxides which do not participate the graft reaction. Therefore, sealing by nitrogen and holding at subzero temperature over the irradiation step provides preferable condition to keep radical activity for the next step (graft copolymerization).

Step-2 (Graft Copolymerization)

After irradiation step, graft copolymerization on the Meltblown is conducted in a vessel filled with reactive vinyl monomer. The monomer is chosen among following vinyl monomers, acrylonitrile (CH₂═CHCN), acrolein glycidyl methacrylate (GMA), chloromethylstyrene glycidyl vinylbenzylether, etc.

Following vinyl monomers having phosphate acid group can be also used.
2-hydroxyethylmethacrylate phosphoric acid (CH₂═C(CH₃)COO(CH₂)₂OPO(OH)₂₎,
di(2-methacryloiloxyethyl)acid phosphate ([CH₂═C(CH₃)COO(CH₂)₂O]₂PO(OH)),
mono(2-methacryloyloxyethyl)acid phosphate (CH₂═CHCOO(CH₂)₂OPO(OH)₂),
di(2-acryloyloxyethyl)acid phosphate ([CH₂═CHCOO(CH₂)₂O]₂PO(OH))

Here, it is noteworthy in this invention that these vinyl monomers are used in a state of emulsion in which micro- or nano-order sized monomer is dispersed in water. To stabilize such emulsion, various kinds of surfactant are used.

Actually, a kind of anionic surfactant based on alkylbenzene, alcohol, olefin, phosphoric acid, amido compounds or sodium dodecyl sulfate are used to make emulsion. Cationic surfactant such as octadecylamine acetate, trimethylammonium chloride or nonionic surfactant such as ethoxylic aliphatic alcohol or fatty acid ester is used. The concentration to the water is not limited, however, in most case, it is chosen from 0.1 to 10%.

The grafting condition affects the grafting ratio and the yield of monomer in the graft reaction. The suitable temperature is found in the range from 10 to 60° C. and reaction time is usually taken from 1 to 120 min. The suitable monomer concentration in emulsion is chosen from 1 to 30%, most preferably from 2 to 20%.

Naturally, the suitable reaction condition depends on the fiber material and fiber size of the Meltblown.

The first step and second step may be combined continuously, however, it is not practical from following reasons.

First, in case of electron beam irradiation, dose is completed in the scale of second and graft reaction is performed in the scale of several minutes or hours, so, it is physically difficult to fit both timing into one continuous operating facilities.

Secondly, in case of gamma ray irradiation, particularly heavy safety protection measures for working place is required. Therefore, it is very difficult to combine irradiation and grafting reaction into one continuous process.

Hence, it is realistic that these two steps should be performed in each independent facility at its most suitable operating condition.

Once irradiation is conducted, then, the Meltblown is kept frozen in refrigerator or dry ice box to avoid disappearance of radicals.

### Step-3 (Conversion of Ion Exchange Group)

At the third step after completing grafting reaction, ion exchange group such as sulfonic acid group, amino group or iminodiacetic acid group is introduced by chemically converting the grafted copolymer having functional vinyl group.

For instance, the grafted glycidyl methacrylate (GMA) grafted through Step-1 and step-2 is sulfonated by sodium hydrogensulfite to give cation exchange function. In the case of animation, amino-exchange group is obtained from grafted GMA having epoxy group by use of diethanolamine.

In another case, a chelate group like iminodiacetate (IDA: —N(CH₂COOH)₂) is imparted from grafted GMA by addition reaction of IDA group (—N(CH₂COOH)₂).

In addition, amidoxime group and phosphoric acid group, carboxylic acid group, ethylene diamine triacetic group, imino diethanol group are also introduced according to the needs for filtration of heavy metals like lead, cadmium, or arsenic ion dissolved in the waste water.

In the case of air filtration, alkaline gases such as ammonium, trimethyldiamine, or acid gases such as NOx, SOx, or formaldehyde and acetaldehyde are effectively adsorbed.

### ADVANTAGE OF THE INVENTION

This invention is particularly featured in low dose of irradiation and effective graft copolymerization through combining the use of the Meltblown comprised of fine fiber less than 8 micron in diameter with the use of emulsified reactive monomer. So, it widens the flexibility to choose the raw material of grafting media and fiber size to obtain more higher grafting ratio without severe polymer degradation. The low dose also makes possible to apply easy-degradable Meltblown made of polypropylene and polyamide to graft polymerization.

The use of Meltblown provides another advantage because of its fine fiber composition. It gives effective contact with flowing liquid, so, ion adsorption under high throughput of flow can be realized.

Fine dust in the liquid flow can be also filtrated effectively because of the exclusive space made by fine fiber of the Meltblown.

Moreover, the Meltblown is comprised of continuous fiber, so, it is distinctive in the form of fiber whether it is continuous or discontinuous (staple) like in Thermal Bonding nonwoven including lint, that is to say, the Meltblown provides lint-free filter media and it is preferable in liquid filtration.

Another benefit of this invention exists in the use of emulsified monomer. No-use of organic solvent like methanol or dimethylsulfoxide should be advantageous from environmental aspect.

### EXAMPLES

The present invention is described in more detail by EXAMPLES, which by no means limit the present invention, and include various variations and modifications so long as they do not deviate scope of the present invention.

### Reference Example

Meltblown made with polyamide-6 is applied to the radiation-induced graft polymerization. The mean fiber diameter was controlled at the level of 4 micron and the basis weight of the meltblown was 50 g/m².

Meltblown was irradiated with 20 kGy of electron beam in air.

After the irradiation, the Meltblown media were preserved in dry ice box maintained the temperature under minus 20° C.

In the next step, the irradiated Meltblown were immersed into a vessel filled with emulsion preliminary mixed and homogenized with 10% of GMA as reactive vinyl monomer and 0.1% of surfactant (trade name “TWEEN 20” supplied from KANTO KAGAKU CO., LTD.) in pure water.

Grafting reaction was conducted at 40° C. in the vessel filled with the emulsion for 2 h for reaction. Nitrogen gas was directly fed in the monomer to keep bubbling state during reaction. The obtained grafting ratio of GMA was 145%.

### Example 1

The Meltblown used in the REFERENCE EXAMPLE was applied.

Irradiation and grafting reaction were performed as same manner as the REFERENCE EXAMPLE, but nitrogen gas bubbling was not introduced. The obtained grafting ratio of GMA was 120%.

### Example 2

The Meltblown (80 g/m² in basis weight) made with HDPE is applied. The mean diameter of fibers was 3 micron. Irradiation and grafting reaction were performed as same as EXAMPLE 1. The obtained grafting ratio of GMA was 101%.

### Example 3

Conversion of ion exchange group was conducted onto the grafted Meltblown obtained in EXAMPLE 1. The grafted Meltblown was immersed in 10% of sodium sulfate solution at 80° C., for 2 h. The converted sulfonic acid group is estimated by following formula (1).

Conversion Ratio (%)=100×A/B (1)

A: MOL of converted epoxy group with sulfonic acid group

B: MOL of epoxy group before conversion

The obtained conversion ratio was 95% as shown in TABLE 1.

### Example 4

Conversion of Ion exchange group was introduced on the grafted Meltblown obtained in EXAMPLE 2.

10% solution of trimethylamine hydrochloride was prepared in adjusting its pH at 9.4 by adding NaOH (1N). The amino-functional group was introduced on the grafted Meltblown in this solution at 80° C., for 1 hour.

The converted amino group is estimated by formula (1) and 95% of conversion ratio was obtained as shown in TABLE 1.

### Example 5

The Meltblown (40 g/m² in basis weight) made with polypropylene is applied. The mean diameter of fibers was 5 micron. Irradiation and grafting reaction were performed as same as EXAMPLE 1.

The obtained grafting ratio of GMA was 105% as shown in TABLE 1.

### Example 6

Adsorption performance was examined.

The sulfonated Meltblown sample obtained in EXAMPLE 1 was packed in a column (7 mm in inner diameter, 20 mm in height) and 10 ppb sodium solution was introduced constantly at the level of SV 100 h⁻¹. In this test, the breakthrough point was observed and the total bed volume at the point was calculated. The bed volume in EXAMPLE 6 was 7,400 (TABLE 1) and it was compared with the result of COMPARATIVE EXAMPLE 5 (TABLE 2).

### Example 7

The Meltblown made with HDPE was used as grafting media. (Its basis weight was 81 g/m² and the mean diameter was 6 micron.)

The Meltblown was preliminary packed in a bag made with gas barrier film and vacuum-sealed and stored in dry ice box before irradiation, then, 20 kGy of Co-60 gamma ray was irradiated.

Graft copolymerization onto this irradiated media was conducted in emulsion containing 1% of GMA and 0.1% of surfactant (TWEEN 20) in pure water.

The graft reaction was performed at 40° C. for 20 min. The result of grafting ratio of GMA was 150%.

The grafting Meltblown was treated with 10% of sodium sulfate solution at 80° C. for 2 h to convert sulfonic acid group on to grafted epoxy group.

The result of conversion was 90%.

### Comparative Example 1

A Spunbond nonwoven (50 g/m² in basis weight) made with low density polyethylene (LDPE) is applied. The mean diameter of fibers was 20 micron. Irradiation and grafting reaction were performed as same manner as EXAMPLE 1.

The obtained grafting ratio of GMA was 0%

### Comparative Example 2

200 kGy of electron beam was irradiated to the spunbond nonwoven used in COMPARATIVE EXAMPLE 1. The grafting reaction was performed as same manner as COMPARATIVE EXAMPLE 1.

The obtained grafting ratio of GMA was 132%.

### Comparative Example 3

Thermal Bonding nonwoven (65 g/m² in basis weight) made with HDPE staple fibers is applied. The mean diameter of fibers was 18 micron. 50 kGy of electron beam was irradiated to this nonwoven media.

The grafting condition was the same as EXAMPLE 1.

The obtained grafting ratio of GMA was 90%.

### Comparative Example 4

Thermal Bonding nonwoven applied in COMPARATIVE EXAMPLE 3 was used.

10% of GMA in methanol (90%) solution was prepared for graft co-polymerization.

The other grafting condition was taken in the same manner as EXAMPLE 1.

The obtained grafting ratio of GMA was 60%.

### Comparative Example 5

200 kGy of electron beam was irradiated to the nonwoven media used in EXAMPLE 3 (Thermal Bonding nonwoven made with HDPE).

The grafting condition was taken in the same manner as EXAMPLE 1 and sulfonation was performed.

The obtained grafting ratio of GMA was 186%.

The adsorption performance was tested in the same manner of EXAMPLE 6 and the adsorption performance was compared. The result is shown in TABLE 2.

TABLE 1

| | Reference | EXAMPLE 1 | EXAMPLE 2 | EXAMPLE 3 | EXAMPLE 4 | EXAMPLE 5 |
|---|---|---|---|---|---|---|
| Type of Nonwoven | Meltblown | Meltblown | Meltblown | Meltblown | Meltblown | Meltblown |
| Raw Material | PA6 | PA6 | HDPE | PA6 | HDPE | PP |
| Fiber Diameter μm | 4 | 4 | 3 | 4 | 3 | 5 |
| Basis Weight g/m2 | 50 | 50 | 80 | 50 | 80 | 40 |
| Process Condition | | | | | | |
| 2) Irradiation | | | | | | |
| Atmosphere | air | air | air | air | air | air |
| Irradiation by: | Electron beam | Electron beam | Electron beam | Electron beam | Electron beam | Electron beam |
| Dosing kGy | 20 | 20 | 20 | 20 | 20 | 20 |
| 3) Grafting | | | | | | |
| Grafting monomer | GMA | | | | | |
| Condition of Monomer | Emulsified | Emulsified | Emulsified | Emulsified | Emulsified | Emulsified |
| Use of solvent | non | non | non | non | non | non |
| N2 | Bubbled | non | non | non | non | non |
| GMA Grafting Ratio % | 145 | 120 | 101 | 120 | 101 | 105 |
| 4) Conversion | | | | | | |
| Type of Functional Group | | | | sulfonic acid | amino | |
| Conversion % | | | | 95 | 95 | |

| | EXAMPLE 6 | EXAMPLE 7 |
|---|---|---|
| Type of Nonwoven | Meltblown | Meltblown |
| Raw Material | PA6 | HDPE |
| Fiber Diameter μm | 4 | 6 |
| Basis Weight g/m2 | 50 | 81 |
| Process Condition | | |
| 2) Irradiation | | |
| Atmosphere | air | vacuum |
| Irradiation by: | Electron beam | Gamma ray |
| Dosing kGy | 20 | 20 |
| 3) Grafting | | |
| Grafting monomer | GMA | GMA |
| Condition on of Monomer | Emulsified | Emulsified |
| Use of solvent | non | non |
| N2 | non | non |
| GMA Grafting Ratio % | 120 | 150 |
| 4) Conversion | | |
| Type of Functional Group | Sulfonic acid | |
| IEC(*) mmol/g(PA6) | 3.4 | |
| IEC meq/column | 0.28 | |
| Break through (Bed Volume | 7400 | |

(*)IEC: Ion Exchange Capacity mmol/g (Unit weight of grafted media, nonwoven)

TABLE 2

| | COMPARATIVE | COMPARATIVE | COMPARATIVE | COMPARATIVE | COMPARATIVE |
|---|---|---|---|---|---|
| | EXAMPLE 1 | EXAMPLE 2 | EXAMPLE 3 | EXAMPLE 4 | EXAMPLE 5 |
| Type of Nonwoven | Spunbond | Spunbond | Thermal Bond | Thermal Bond | Thermal Bond |
| Raw Material | LDPE | LDPE | HDPE | HDPE | HDPE |
| Fiber Diameter μm | 20 | 20 | 18 | 18 | 18 |
| Basis Weight g/m2 | 50 | 50 | 65 | 65 | 65 |
| Process Condition | | | | | |
| 2) Irradiation | | | | | |
| Atmosphere | in air | in air | in air | in N2 | in N2 |
| Irradiation by: | Electron beam | Electron beam | Electron beam | Electron beam | Electron beam |
| Dosing kGy | 20 | 200 | 50 | 50 | 200 |
| 3) Grafting | | | | | |
| Grafting monomer | GMA | GMA | GMA | GMA | GMA |
| Condition on of Monomer | Emulsified | Emulsified | Emulsified | in solvent | in solvent |
| Use of sovent | non | non | non | Methanol | Methanol |
| N2 | non | non | non | Bubbled | Bubbled |
| GMA Grafting Ratio % | 0 | 132 | 90 | 60 | 186 |
| 4) Conversion | | | | | |
| Type of Functional Group | | | | | Sulfonic acid |
| IEC(*) mmol/g(PA6) | | | | | 3.3 |
| IEC meq/column | | | | | 0.38 |
| Break through (Bed Volume) | | | | | 7200 |

### Reviewing the Result

Reviewing over the test result shown in TABLE 1 and TABLE 2, it is evident that high graft ratio higher than 100% was obtained through EXAMPLES 1 to 7 even in the low irradiation dose (20 kGy).

To the contrary, in case of LDPE Spunbond nonwoven composed of 20 micron fiber, it showed no grafting reaction at 20 kGy dose (COMPARATIVE EXAMPLE 1), whereas high level of dose (200 kGy) was necessary for required grafting ratio higher than 100% (COMPARATIVE EXAMPLE 2). In comparing EXAMPLES 1 to 5 with COMPARATIVE EXAMPLE 4, the use of GMA diluted with methanol even in nitrogen atmosphere did not give high grafting ratio under low Irradiation dose (60 kGy).

In Na-ion adsorption test, EXAMPLE 6 showed comparable breakthrough point to those of COMPATATIVE EXAMPLE 5 (60%).

What is claimed is:

1. A functional filter medium obtained by a process comprising;
(a) subjecting a nonwoven fabric to irradiation with electron beam or gamma-ray at a dose of less than 30 kGy in air or nitrogen atmosphere, said nonwoven fabric being a meltblown nonwoven fabric comprising fibers of a polyolefin and/or polyamide each having a diameter less than 8 microns, to thereby obtain an irradiated nonwoven fabric; and
(b) subjecting said irradiated nonwoven fabric to liquid-phase graft copolymerization by contacting said irradiated nonwoven fabric with a reactive monomer emulsified in a continuous phase liquid, said reactive monomer having a functional group, to thereby obtain said functional filter medium.

2. The filter medium according to claim 1, wherein said process further comprises converting said functional group to at least one ion exchange group.

3. The filter medium according to claim 2, wherein said ion exchange group is at least one member selected from the group consisting of a sulfonic acid group, an amino group and an imino-diacetic acid (IDA) group.

4. The filter medium according to claim 1, wherein said polyolefin is at least one member selected from the group consisting of a polypropylene, a polyethylene, an ethylene-propylene copolymer and an ethylene-alpha olefin copolymer.

5. The filter medium according to claim 1, wherein said reactive monomer has a vinyl group and is emulsified in water as said continuous phase liquid using a surfactant.
